(19) United States
(12) Patent Application Publication
(10) Pub. No.: US 2015/0347624 A1
(43) Pub. Date: Dec. 3, 2015

(54) SYSTEMS AND METHODS FOR LINKING AND ANALYZING DATA FROM DISPARATE DATA SETS

(71) Applicant: MasterCard International Incorporated, Purchase, NY (US)

(72) Inventor: Curtis Villars, Chatham, NJ (US)

(73) Assignee: MasterCard International Incorporated, Purchase, NY (US)

(21) Appl. No.: 14/290,571

(22) Filed: May 29, 2014

(51) Int. Cl. G06F 17/30; G06Q 30/02

(52) U.S. Cl. CPC G06F 17/30952; G06Q 30/0204; G06F 17/30958; G06Q 50/01

(57) ABSTRACT

Systems and methods for linking or matching data of disparate datasets and then performing business related data analysis. Consumer-related data of two or more disparate datasets are linked in a privacy-friendly manner, and then analyzed to provide business information and/or consumer information to clients. The linking and analysis is performed in a manner to protect personally identifiable information (PII) of the consumers. In an embodiment, a processor receives a plurality of disparate anonymized datasets originating from a plurality of different data sources, formats the de-identified data to provide a plurality of formatted anonymized datasets, and links the data entries of the de-identified individuals by matching at least date data, time data, and location data. The processor then analyzes the activity data of the linked data entries, and generates a report based on the analysis.

### FIELD OF THE DISCLOSURE

Embodiments generally relate to transaction processing systems and methods. More particularly, embodiments relate to linking consumer-related data of disparate datasets in a privacy-friendly manner, performing data analysis, and then providing business related information to clients without exposing any personally identifiable information.

### BACKGROUND

Payment processors, networks and other entities create and process large amounts of consumer spending and payment-related data each day. The data is collected and stored to support transaction processing and for other purposes related to ensuring that the parties involved in a transaction are properly compensated. The data has other potential uses as well, including for use to identify and/or analyze consumer spending patterns and behaviors. Thus, strict limitations have been applied to the access to and to the use of such transaction data, because it is important that the transaction details be “de-identified” from any private or personally identifiable information (sometimes referred to as “PII”) of consumers. The use of such de-identified data when identifying and analyzing consumer spending patterns, behaviors and/or tendencies ensures the privacy of the consumers.

It would be desirable to provide systems and methods that allow for the analysis of large volumes of transaction data using de-identified data sets. Furthermore, it would be desirable to provide a linkage method for linking or matching data from one data source (such as a merchant's sales ledger) to transaction data from a second, disparate data source (such as a payment network), to thereby provide an ability to construct or generate analyses, reports and other applications based on the linked data sets.

### BRIEF DESCRIPTION OF THE DRAWINGS

Features and advantages of some embodiments, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a block diagram illustrating a transaction analysis system according to some embodiments of the disclosure;

FIGS. 2A-1 and 2A-2 illustrate a first dataset in table format, and FIG. 2B illustrates a second dataset in table format, in accordance with some embodiments of the disclosure;

FIG. 3 is a flowchart of a process for operating the transaction analysis system of FIG. 1 pursuant to some embodiments; and

FIG. 4 is a block diagram of an anonymized data analysis computer according to some embodiments of the disclosure.

### DETAILED DESCRIPTION

Embodiments generally relate to systems and methods for linking or matching data of disparate datasets and then performing business related data analysis. More particularly, embodiments relate to systems and methods for linking or matching consumer-related or user-related data of two or more disparate datasets in a privacy-friendly manner, and then analyzing the linked data to provide business information and/or consumer information to clients. The linking and analysis is performed in a manner that protects PII of the consumers and/or users. For example, de-identified data of individuals from a first transaction data provider (such as a payment card network) and data from a second transaction data provider (such as a merchant or group of merchants) is linked, and then the linked data entries are analyzed in a manner to ensure that PII of the consumers and/or users is not revealed or accessible during or after the analysis. In some embodiments, one or more reports are generated and then provided to one or more clients. Such reports may highlight or describe consumer and/or user patterns, tendencies and/or trends and do not include any PII, but may be useful to clients (such as merchants) to make business decisions regarding business operations and/or for business planning purposes.

A number of terms are used herein. For example, the term “de-identified data” or “de-identified data sets” are used to refer to data or data sets that have been processed or filtered to remove any PII. Entities may provide de-identified data utilizing any number of processes that function to filter out all personally-identifiable data of consumers, and which may assign or associate a de-identified unique identifier (or de-identified unique “ID”) with each record.

It should be understood that the term “payment card network” or “payment network” as used herein refers to a payment network or payment system operated by a payment processing entity, such as MasterCard International Incorporated, or other networks which process payment transactions on behalf of a number of merchants, issuers and payment account holders (such as credit card and/or debit card account cardholders). In addition, the terms “payment card network data” or “network transaction data” or “payment account network transaction data” refer to transaction data associated with payment transactions that have been processed over a payment network. For example, network transaction data may include a number of data records associated with individual payment transactions (or purchase transactions) of consumers that have been processed over a payment card network. In some embodiments, network transaction data may include information that identifies a payment device or payment account, transaction date and time, transaction amount, and information identifying a merchant and/or a merchant category. Additional transaction details may be available in some embodiments.

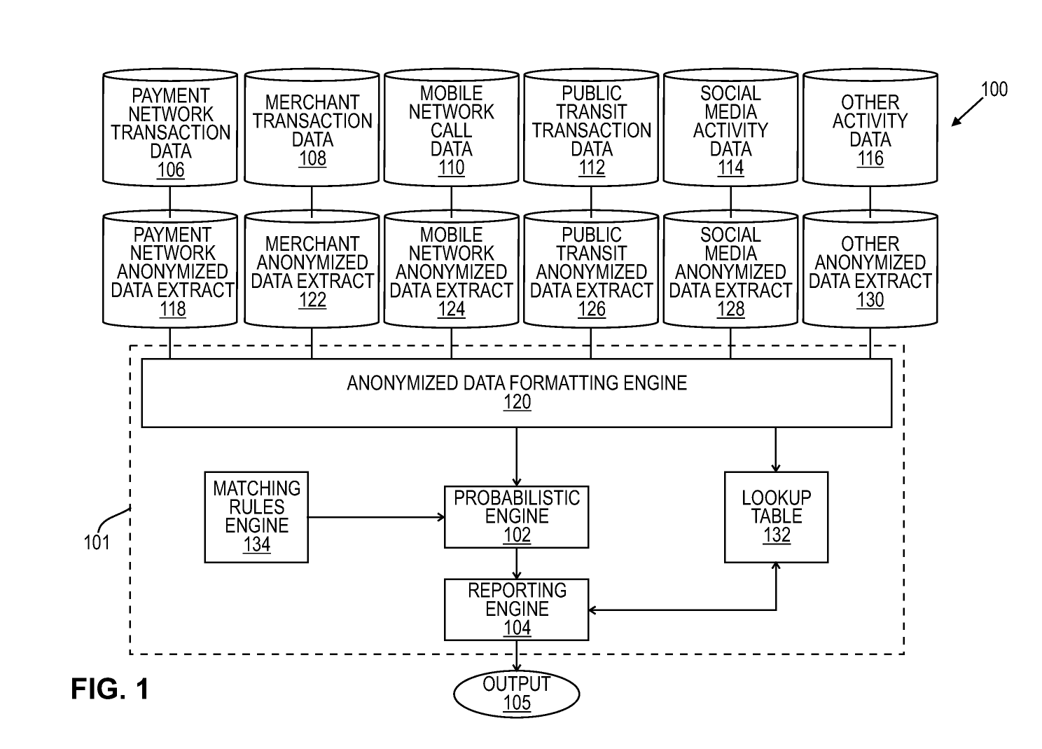

FIG. 1 is a block diagram illustrating a transaction analysis system 100 according to some embodiments. Some or all of the components of the transaction analysis system may be operated by or on behalf of an entity providing transaction analysis services. For example, in some embodiments, the system 100 may be operated by or on behalf of a payment network or association (e.g., such as MasterCard International Incorporated) as a service for entities such as member banks, merchants, or the like.

The transaction analysis system 100 includes a probabilistic engine 102 in communication with a reporting engine 104 that is operable to generate an output 105 that may take the form of reports, analyses, and/or data extracts associated with data matched or linked or otherwise processed by the probabilistic engine 102. In some embodiments, the probabilistic engine 102 is configured to receive and/or analyze data from a plurality of data sources, including payment network transaction data 106 (e.g., from payment transactions made or processed over a payment card network), merchant transaction data 108 (e.g., from purchase transactions conducted at one or more merchant retail locations and/or via a retail website and the like), mobile network call data 110 (e.g., from one or more mobile network operators (MNOs)), public transit transaction data 112 (e.g., from a metropolitan public transportation organization), social media activity data 114 (e.g., from social media organizations and/or websites such as Facebook™, Twitter™, LinkedIn™, Pinterest™, Google Plus+™, TumblrTm, Instagram™, and/or Flickr™), and/or from other activity or other transaction data 116 (for example, activity or transaction data captured by smartphone applications).

In some embodiments, the data from each data source 106 to 116 is pre-processed before it is analyzed by the probabilistic engine 102. For example, the payment network transaction data 106, which may include payment card transaction data, is used to first create a payment network anonymized data extract 118 wherein any and all PII is removed. In some embodiments, the payment network anonymized data extract 118 is created by first generating a de-identified customer unique identifier code that is derived from a consumer identifier associated with each payment transaction in the payment network transaction data 106 (which may be considered as being source data). For example, a function may be applied to a consumer identifier associated with each transaction and transaction record of the payment network transaction data to create a de-identified consumer unique identifier associated with each consumer in the dataset. In some embodiments, the function may be a hash function or other function so long as the consumer unique identifier cannot by itself be linked to an individual or consumer (for example, an entity that has access to the anonymized data extract 118 is not able to identify any PII associated with a de-identified unique identifier in the data extract 118). In some embodiments, the payment network carries out the anonymizing process(es). The payment network anonymized data extract 118 may then be fed to an anonymized data formatting engine 120, which may operate to aggregate or group all of the transactions of a particular consumer together in a particular data format (for example, by first locating all transactions associated with a de-identified consumer user unique identifier (UID) and then listing that data in date order) before that data is fed to the probabilistic engine 102 for further processing.

Referring again to FIG. 1, the merchant transaction data 108 may also be pre-processed to provide a merchant anonymized data extract 122, the mobile network call data may be pre-processed to provide a mobile network anonymized data extract 124, the public transit transaction data may be pre-processed to provide a public transit anonymized data extract 126, the social media activity data may be pre-processed to provide a social media anonymized data extract 128, and the other activity data may be pre-processed to provide an other activity anonymized data extract 130. In some embodiments, each of the anonymized data extracts 118, 122, 124, 126, 128 and 130 contains data entries that include a unique anonymized customer identifier along with a time and date of the transaction or activity, and other data.

For example, the merchant transaction data 108 may include sales ledger data in a pre-defined format that contains information associated with a plurality of transactions conducted at the merchant. Such merchant transaction data may include, but is not limited to, transaction date and time, a customer unique identifier, the total transaction amount, a list of items purchased (which may include information such as SKU or other item identifiers), a store location and the like. As mentioned above, the customer unique identifier (which may be a user unique identifier or “UID”) is generated such that it is not personally identifiable (although it may be personally identifiable with additional information known to the merchant). Thus, the customer UID is a de-identified unique identifier, and it may be generated from the transaction data received from the merchant point-of-sale (POS) systems for continuity between transactions, and thus may be selected to be persistent across transactions. For example, the customer UID may show up numerous times throughout a data file provided by a merchant (e.g., the customer UID may be associated with transactions performed at different store locations, at different times, and with different transaction amounts). In some embodiments, the merchant data extract is tender agnostic, and thus includes transactions conducted with cash, payment cards, debit cards, gift cards, loyalty cards, or the like, and may be provided to an entity operating the system via a secure file transfer (e.g., via sFTP or the like) and be associated with a unique merchant identifier. Thus, in general, the number of merchant transactions in the merchant anonymized data extract 122 may be greater than the number of payment network transactions found in the data extract 118 for that particular merchant. This may be the case because the merchant data extract can include transactions conducted with other, different types of tenders (for example, cash transactions and/or loyalty card transactions which are not processed by the payment network) in addition to the payment network transactions (for example, credit card transactions and/or debit card transactions).

Similarly, the mobile network call data 110 may include time, location and date data of a mobile telephone call and/or text message, a mobile customer unique identifier, the duration of the call, and location coordinates associated with a plurality of mobile telephone calls. The mobile customer unique identifier is generated such that it is not personally identifiable (although it may be personally identifiable with additional information known to the mobile network operator). Thus, the mobile customer unique identifier is a de-identified unique identifier, and it may be generated from the mobile telephone call data by the mobile network operator for continuity to discern the mobile telephone calls of a particular customer. Thus, the mobile customer unique identifier may show up numerous times throughout a mobile network anonymized data extract data file provided by the mobile network operator (MNO) to the anonymized data formatting engine 120 (e.g., the mobile customer unique identifier may be associated with numerous mobile telephone calls performed at different locations, at different times, and having different durations and/or mobile roaming charge amounts).

The public transit transaction data 112 may include public transportation location data (e.g., the location of a train station), a transit customer unique identifier, a time and date data of payment of a fare (for example, payment obtained upon entering and/or exiting a subway station) by a transit customer, and the like. The transit customer unique identifier is generated such that it is not personally identifiable (although it may be personally identifiable with additional information known to the public transportation authority). Thus, the transit customer unique identifier is a de-identified unique identifier, and it may be generated from the public transit transaction data by the transportation authority for continuity to discern public transit or ridership patterns of a particular transit customer. Thus, the transit customer unique identifier may show up numerous times throughout a public transit anonymized data extract data file provided by the public transit authority to the anonymized data formatting engine 120 (e.g., the transit customer unique identifier may be associated with numerous fares paid at different public station locations, at different times, and for different types of rides and/or fare amounts).

As mentioned earlier, the social media activity data 114 may include activity data from various websites operated by companies or organizations such as Facebook™ Twitter™, LinkedIn™, Pinterest™, Google Plus+™, Tumblr™, Instagram™ Foursquare™ and/or Flickr™. The social media data may include a social media UID, time and date of user activity (e.g. the date and time when a user posted a comment or picture, or tweeted, or checked-in at a retail store (for example, a Foursquare check-in), or clicked on an advertisement on a webpage, or engaged in some other activity associated with a webpage and/or website), and a description of the type or types of activity data (for example, entering a tweet on Twitter™, observing a profile page on LinkedIn™, or playing an interactive social game on Facebook™). The social media user unique identifier is generated such that it is not personally identifiable (although it may be personally identifiable with additional information known to a particular social media operator, for example). Thus, the social media user unique identifier is a de-identified unique identifier, and it may be generated by a social media operator from activity data for continuity purposes to discern user activity, for example. The social media user unique identifier may therefore appear numerous times throughout a social media anonymized data extract data file provided by one or more social media organizations to the anonymized data formatting engine 120 (e.g., the social media user unique identifier may be associated with numerous types of activities that occurred at various times).

The other activity data 116 may be aggregated by other types of entities or organizations that provide and/or sponsor many different types of smartphone applications (or “Apps”) that capture many different types of consumer attributes, including location data and time data that can be gathered and then utilized. The user unique identifier (UID) is generated such that it is not personally identifiable, and thus the UID is a de-identified unique identifier. The UID may also be generated in such manner that the UID appears numerous times throughout the other activity anonymized data extract data file that is provided by the other activity organization or operator to the anonymized data formatting engine 120.

Pursuant to embodiments disclosed herein, each dataset generated by the anonymized data extract modules 118, 122, 124, 126, 128 and 130 contains entries corresponding to a date, a time, a location and activity details by individual or consumer UID that contains no PII. Thus, in some embodiments, the payment network anonymized data extract module 118 provides a data extract of the same type of information that is provided by a merchant or by the merchant anonymized data extract module 122 (e.g., UID, transaction date and time, transaction amount, store location, frequency data and/or other activity data). In some embodiments, one or more of the anonymized data extract modules may provide a sample anonymized dataset of a larger set of data, or it may be an entire data set. Further, in some implementations, when extracting payment network data (at 118), for example, information associated with the merchant or merchants for which an analysis is to be performed (the client or clients) may be used to limit the extract. For example, if an analysis is to be performed for a specific merchant A, the payment network anonymized data extract module 118 may generate an anonymized dataset that is filtered to be limited to transactions performed at merchant A store locations and/or merchant A internet sales (which may include all merchant retail store locations or a subset thereof, which could be defined as all locations in a specific geographical region). Accordingly, the payment network anonymized data extract module 118 may filter the transaction data to exclude other merchant transaction data and to include a number of records of data, each including a de-identified UID of a consumer, a transaction date, a transaction time, a transaction amount or spend, a store location identifier of merchant A (identifying a specific store or merchant location), and activity data. In other embodiments, the transaction data may be filtered to include an aggregate merchant identifier (identifying a specific merchant chain or top level identifier associated with a merchant), or filtered to include a specific type of merchant while excluding other types of merchants. Those skilled in the art, upon reading this disclosure, will appreciate that other data fields may also be filtered and thus excluded, and/or added or included, depending on the nature of the analysis to be performed.

With respect to the merchant data extract provided by the merchant anonymized data extract module 122 based on the merchant transaction data 108, in some embodiments, the extract module retrieves data elements including a customer UID, a transaction date, a transaction time, a transaction spend, and a store location ID (although those skilled in the art will appreciate that additional or other fields may be extracted depending on the nature of the analysis to be performed).

In some embodiments, the function or process of generating an anonymized data extract dataset may be performed by the data extract modules 118, 122, 124, 126, 128 and/or 130, which are owned and/or operated by the entity providing the data, or may be owned and/or operated by third party providers associated with the entity providing the data. For example, the payment network anonymized data extract module 118 may be owned and/or operated by the payment association or the payment network associated with the payment network transaction data, and the payment network transaction data may be provided as an input or batch file to the entity operating the data extract module.

As another example, the anonymized data extract module 122 may be owned by, and operated on behalf of, a group of merchants wishing to receive consumer and/or business reports or analyses.

In some embodiments, the transaction analysis system 100 includes an anonymized data analysis subsystem 101 that includes the anonymized data formatting engine 120, the probabilistic engine 102, the reporting engine 104, a lookup table 132 and a matching rules engine 134. The anonymized data analysis subsystem 101 may be operated by an entity such as MasterCard International Incorporated, to provide consumer and/or business analysis data to clients, such as merchants, in a manner that protects the PII of individuals. In some embodiments, one or more processors, computers and/or computer systems may constitute the anonymized data analysis subsystem 101, along with one or more storage devices. In addition, in some embodiments, the anonymized data formatting engine 120 may include software and/or instructions for filtering and/or otherwise limiting the anonymized data extract data entries received from the various anonymized data extract modules 118 to 130 while also performing a formatting function.

Referring again to FIG. 1, the anonymized data formatting engine 120 may include data, rules and/or criteria which define one or more different and/or separate patterns that have been identified for analysis. Each pattern may be identified by a unique pattern identifier which may be, for example, a random number. Thus, in some implementations, the anonymized data formatting engine 120 is configured to arrange the data received from the anonymized data extract modules 118 to 130 in accordance with a pre-determined or pre-defined pattern. In addition, in some embodiments the anonymized data formatting engine 120 filter the arranged de-identified data in accordance with at least one predetermined time-based criteria. Such time-based criteria may include one or more of a time frame, a time range, and a tolerance rule. In some implementations, the anonymized data formatting engine 120 may instead or additionally filter the arranged de-identified data in accordance with at least one predetermined client-based criteria. For example, it may be desirable to include de-identified data of individuals who shop at a particular merchant store or stores. Thus, the client-based criteria may include one or more of a merchant identifier, a merchant type, and a merchant group, which may be utilized to include only certain merchants or exclude certain merchants from the data analysis. The anonymized data formatting engine 120 may also function to arrange the data to conform to a predefined time period or range, for each individual (or consumer or customer or user).

Thus, the data may be formatted to include a plurality of entries for each de-identified UID (associated with the consumers or users or customers) that includes a date, a time, a location, and an activity. The date and time could be summarized in accordance with various tolerance rules, for example, the time may be summarized to the hour, the date summarized to the week, and/or bands of time may be utilized. It should be understood, however, that other combinations of data for which pattern analysis is desired may be specified in accordance with rules and/or criteria that may depend upon the type or types of analysis desired. As mentioned above, the formatting of the data received from the anonymized data extract modules may include filtering or cleansing the data to remove any unnecessary data. For example, with regards to data provided by merchants, the merchant data may be cleansed to remove all fields other than a de-identified customer identifier or UID, a transaction date, a transaction time, a location ID and activity data. In addition, all data provided by merchants that occurred during a time frame that is not of interest may be filtered out and/or discarded. Thus, in some embodiments, during operation the anonymized data formatting engine 120 generates a file, table or other extract of data according to a predefined format for use as an input to the probabilistic engine 102, and which is based on the anonymized and extracted transaction data and/or activity data of individuals. In some embodiments, the anonymized data formatting engine 120 may therefore be operated to generate a file, table or other extract of data that includes a number of transactions filtered and/or grouped according to the de-identified unique IDs of consumers or individuals (for example, a group of transactions associated with a particular consumer that occurred on different dates, at different times, and in many locations conforming to a predetermined set of criteria).

In some implementations, the anonymized data formatting engine 120 may also summarize and/or profile the data by each unique combination of transaction date/time/location and activity. In this case, the anonymized data formatting engine 120 may assign a profile identifier to each pattern, and remove the de-identified UID from the datasets before provision to the probabilistic engine 102. In some embodiments, the removed UID and the assigned profile identifier may be stored in a lookup table 132 (or other type of database) for later use by the reporting engine 104. For example, the reporting engine 104 may search the lookup table 132 to obtain at least one UID associated with the analyzed data, locate detailed de-identified data associated with the UID, and then add the detailed de-identified data to the analysis.

In some embodiments, the probabilistic engine 102 operates to perform an inferred match analysis to link individuals of the disparate datasets (which datasets are provided by different entities, such as those described herein like payment network operators, merchants, mobile network operators, social media companies, and the like) by examining date, time, and location patterns over a predetermined time or time frame. De-identified individual identifiers or UIDs are utilized along with rules and/or criteria which may be provided by a matching rules engine 134 to link groups of data across the various datasets. This allows further assurance of anonymity and avoids use of any PII. Pursuant to some embodiments, a uniqueness probability may be derived from the relationship between the number of matching unique ID entries from one dataset to another. As the probability of a direct link (driven by uniqueness) approaches 100%, the risk of divulging or revealing some PII may increase. For data analysis to identify product or marketing effectiveness, a pattern match of 100% is ideal. Thus, as the uniqueness of the match approaches 0%, the product or marketing effectiveness decreases significantly. By using features described herein to identify the uniqueness probability using anonymized transaction data, embodiments allow marketers, product developers, and analysts to identify trends or actual patterns and to adjust marketing, product development and other features accordingly.

In general, as used herein, the term “direct linkage” refers to the relationship between the probability match and the uniqueness probability. A 100% “direct linkage” occurs when the probability match is 100% and the uniqueness probability is 100%. Pursuant to some embodiments, the primary inferred match corresponds to those records having the highest probabilities within a predetermined acceptance range or tolerance range. However, in some implementations of the methods disclosed herein, matches identified as being a 100% direct linkage are excluded from consideration (and thus not utilized) because such linkages are considered “too good” for inclusion in any data analysis (where no personally identifiable information should be used) as some level of uncertainty is desirable so as to ensure that no individuals are re-identified. In particular, in order to ensure that the data being analyzed is de-identified data then a moderate amount of uncertainty is required. Re-identifying individuals can be avoided by either reducing the precision of linkages or by aggregating results into a small group of individuals.

Pursuant to some embodiments, the output of the processing performed by the transaction analysis system 100 may be an analysis or report which is generated by the reporting engine 104. In some embodiments, to facilitate the reporting and to ensure that PII is not divulged, the reporting engine 104 may use an assigned profile identifier stored in the lookup table 132, which ensures that the de-identified customers or individuals remain de-identified. A wide variety of analyses may be possible based on the data produced to generate such reports, for example, predictive modeling, forecasting, benchmarking, bench marketing, affinity analysis, correlations, and the like.

It should be understood that the various blocks or modules shown in FIG. 1 may represent any number of processors, computers and/or computer systems configured for communicating information via any type of communication network, and communications may be in a secured or unsecured manner. In some embodiments, however, the modules depicted in FIG. 1 are software modules operating on one or more computers. In some embodiments, control of the input, execution and outputs of some or all of the modules may be via a user interface module (not shown) which includes a thin or thick client application in addition to, or instead of a web browser.

As used herein, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. In addition, entire modules, or portions thereof, may also be implemented in programmable hardware devices such as field programmable gate arrays, programmable array logic, programmable logic devices or the like or as hardwired integrated circuits.

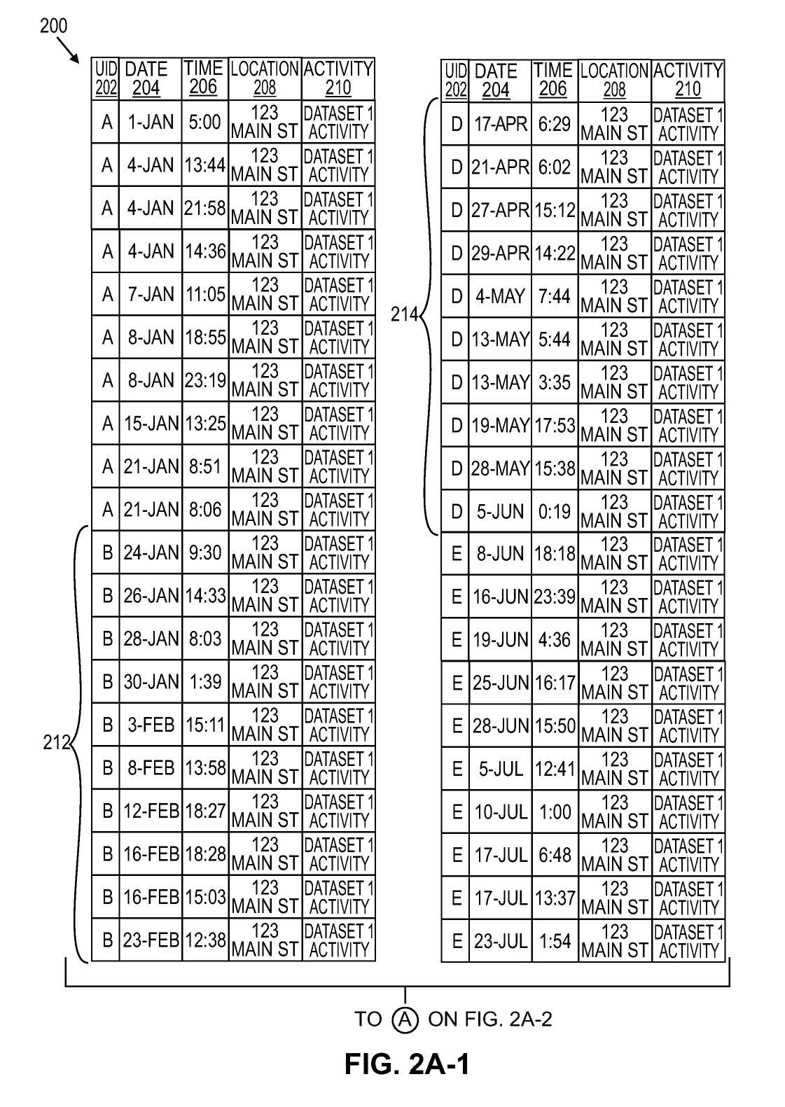

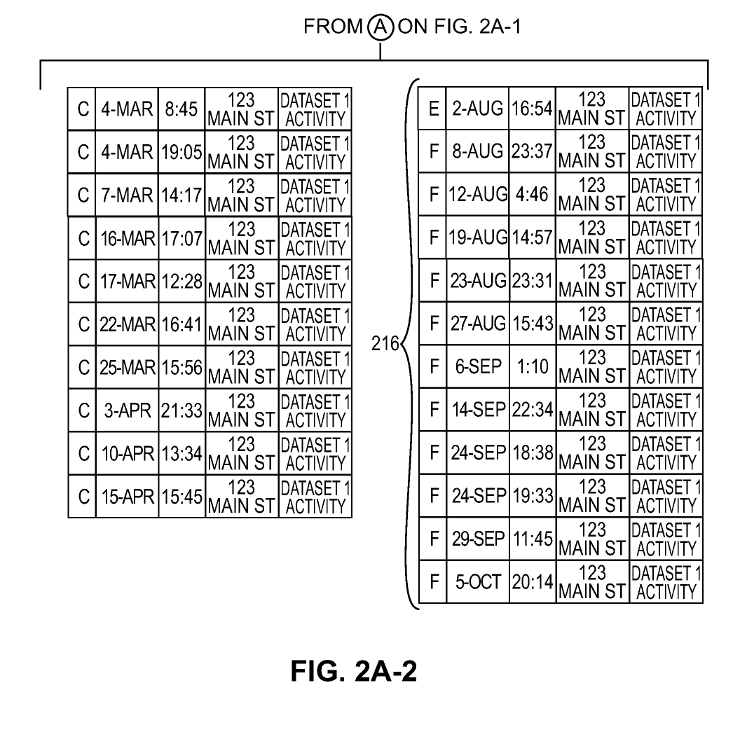

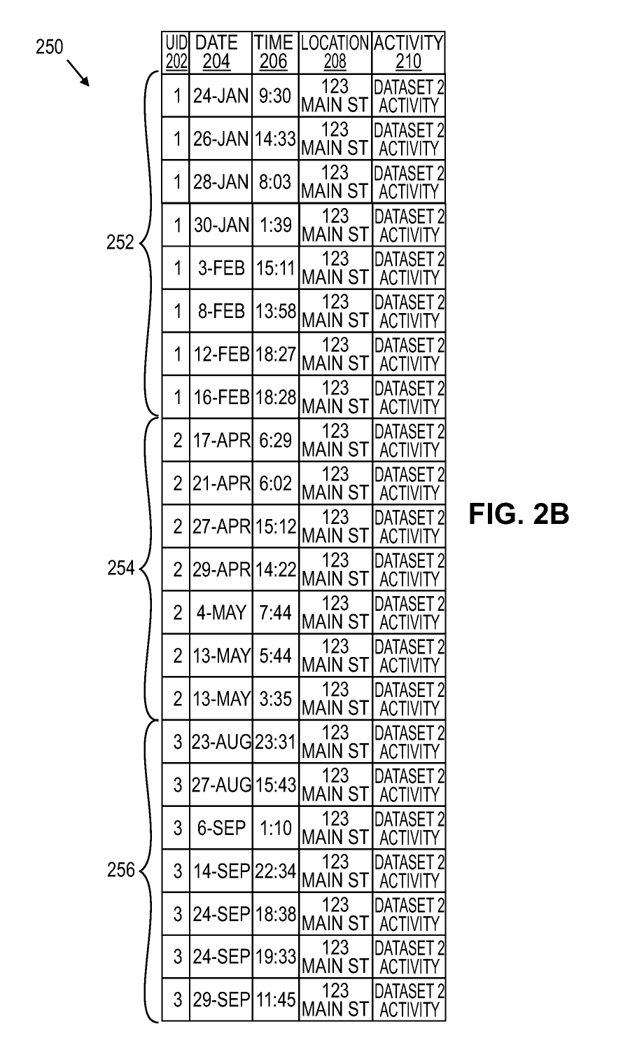

FIGS. 2A-1 and 2A-2 illustrate a first dataset 200, and FIG. 2B illustrates a second dataset 250 in table format in accordance with some embodiments of the disclosure. Such datasets may be generated by the anonymized data formatting engine 120 for input to the probabilistic engine 102. Referring to dataset or table 200, the columns include a de-identified UID 202, a date 204, a time 206, a location 208 and activity information 210. For example, the first dataset 200 may correspond to anonymized data that was provided by a payment network, whereas the second dataset 250 (FIG. 2B) may correspond to anonymized data that was provided by a merchant or merchants. In these examples, the location data for all entries corresponds to “123 Main Street,” which may be a merchant store location, for example. Thus, with regard to FIG. 2A, the data entries for “Individual B” 212 have been grouped together as shown, and may be compared to the data entries of the second dataset 250 by the probabilistic engine 102 in accordance with criteria or rules provided by the matching rules engine 134. In this example, it is found that the data for “Individual B” 212 of the first dataset 200 matches the data for “Individual 1” 252 of the second dataset 250 because eight of the ten entries for “Individual B” match the eight data entries of “Individual 1.” Thus, Individual B and Individual 1 are matched or linked and are considered to be the same individual for analysis purposes. Similarly, the data for “Individual D” 214 of the first dataset 200 matches the data for “Individual 2” 254 of the second dataset 250 because seven of the ten entries for “Individual D” match the seven data entries of “Individual 2.” Thus, Individual D and Individual 2 are matched and are considered to be the same individual for data analysis purposes. In addition, the data for “Individual F” 216 of the first dataset 200 matches the data for “Individual 3” 256 of the second dataset 250 because seven of the eleven entries for “Individual F” match the seven data entries of “Individual 3.” Thus, Individual F and Individual 3 are matched or linked and are considered to be the same individual for analysis purposes. Accordingly, three individuals (or customers or consumers or users) have been matched or linked for analysis purposes.

In some embodiments, the probability of a match or linkage occurring can be assigned depending on the number of unique combinations in a pattern, and once a match or link is established, activity from two or more datasets can be combined for analysis purposes. As mentioned above, activity data may include, but are not limited to, details concerning credit card transactions, SKU level transactions, transit transactions (for example, entering and/or exiting a subway station), wireless cell phone calls, text messages, twitter tweets, activity data regarding location generated from a mobile application leveraging a cell phone's GPS capability, Foursquare check-ins, and any other activity that would include date, time and location data.

Thus, in some implementations, a consumer pattern or user pattern may be derived even though there is some uncertainty regarding whether the activity data are correctly matched for any number of particular consumers or individuals. But in some embodiments another point of reference may be utilized, for example zip code data, in an attempt to erase or minimize some of the uncertainty and/or to smooth out some of the “noise” in the data concerning matched data patterns of consumers. Thus, in some embodiments individuals that have similar data patterns may be grouped together to discern a consumer pattern or patterns of behavior. In this manner, observations and/or assumptions can be made concerning certain groups of individuals or consumers, and then such observations and/or assumptions may be provided to one or more clients (such as a merchant) in a report generated by the reporting engine 104. For example, by analyzing consumer data patterns for all individuals during a predetermined time frame in a particular zip code, it may be found that people who make eight or more cell phone calls per day purchase two or more beverages from a particular coffee shop chain store. In another example, an analysis of consumer data patterns during July may indicate that consumers who utilize a Facebook™ mobile application two or more times per day are likely to purchase ice cream at least once a week, and/or people who perform a digital check-in using an application on their mobile phones (such as Foursquare) are likely to buy clothing at a particular trendy clothing retailer.

In addition, in some embodiments, it may be possible to analyze social media activity data to discern that consumers have been complaining about a particular retailer (for example, via posting of negative tweets, or negative comments on their Facebook page, or negative text messages) during a particular time period (for example, the “back-to-school” shopping period) and then provide an alert via the reporting engine 104 to that retailer so that action can be taken to address any problems that occurred. Accordingly, the probabilistic engine 102 may be configured, for example with criteria and/or rules from the matching rules engine 134, to run one or more computer programs having instructions that distill insights and/or analytics data from the anonymized consumer pattern data that are responsive to client queries (such as questions from merchants of a particular mall regarding consumer spending behavior during a particular period of time). The answers and/or reports supplied to the clients may inform client decisions regarding how best to proceed to solve business problems and/or increase revenues. For example, if it is found that consumers who shop at a particular shopping mall on Saturday afternoons in March tend to leave before five o'clock and eat at restaurants less than five miles away from the shopping mall, then the restaurant tenants of the shopping mall may decide to offer discount coupons or conduct some other type of promotion in an attempt to lure consumers to their restaurants for dinner on Saturday nights.

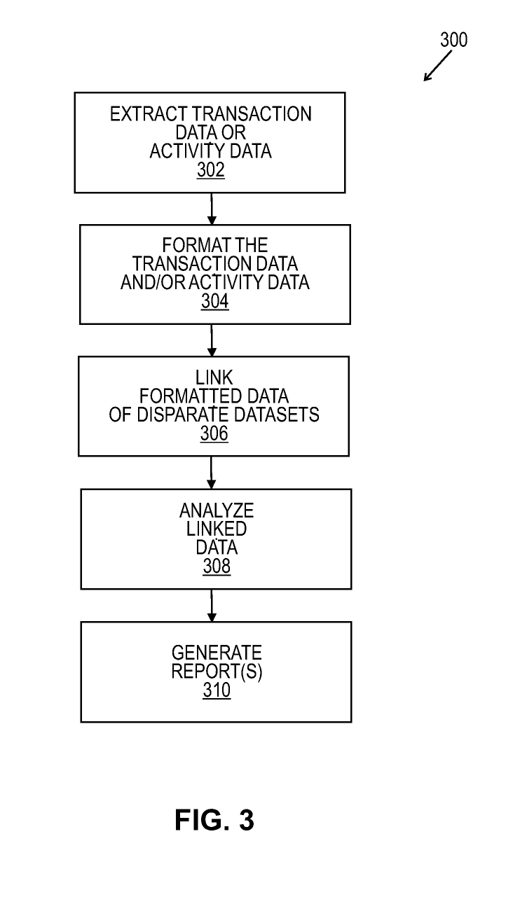

FIG. 3 is a flowchart of a process 300 for operating the transaction analysis system 100 of FIG. 1 pursuant to some embodiments. Thus, some or all of the process steps shown in FIG. 3 may be performed under control of the transaction analysis system 100 and/or the anonymized data analysis subsystem 101, and may include users or administrators interacting with the system via one or more user devices and/or input devices (not shown).

Referring to FIG. 3, transaction data or activity data is extracted 302 from a transaction data store (such as payment network transaction data store 106) or from an activity data store (such as the social media activity data store 114) of disparate datasets to provide de-identified datasets. For example, de-identified data extracts may include an extract of fields for payment network transactions, including a de-identified UID which may be generated as described above, an aggregate merchant ID, a transaction date, merchant data, a transaction time, location data, purchase transaction amount data, and/or other activity data. In the case where the payment network is the network operated by MasterCard International Incorporated, the data extract includes a number of transactions conducted using MasterCard-branded payment cards.

Next, the de-identified data of the disparate data sets extracted at step 302 is formatted 304 to produce a predetermined file format or table format representing each disparate dataset for input to the probabilistic engine 102. For example, the formatted data of a particular dataset may be a table containing data for a particular time period for individuals or consumers shopping or residing in a particular geographical area which is provided or presented in a particular manner. In some embodiments, each entry of the formatted datasets includes a UID, date data, time data, location data and activity data. For example, the data may be formatted as a table containing a predetermined amount of columns corresponding to a de-identified UID, a transaction date, a transaction time, a transaction spend, a location identifier, and activity data.

The formatted data of the disparate datasets is then linked 306 by the probabilistic engine 102. For example, tables provided to the probabilistic engine 102 include a number of transactions with a number of fields, such as a de-identified UID, a transaction date, a transaction time, a location identifier and activity data. The probabilistic engine links or matches the entries based on the date data, time data and locations data. Next, the linked dated is analyzed 308, and one or more reports are generated 310 which highlight the analyzed data for use by clients. In some embodiments, the entity operating the transaction analysis system (such as the transaction analysis system 100 or anonymized data analysis subsystem 101 of FIG. 1) contracts with one or more clients (such as a merchant or a merchant group) to provide reports in exchange for a fee. The analysis performed, and thus the report provided, may be targeted to providing answers or solutions to one or more problems or queries from the client(s) and may involve the use of some transaction data and/or activity data provided by one or more clients. In addition, other types of agreements can be reached between one or more transaction data providers and the operator of the transaction analysis system. Thus, many different types of compensation structures are contemplated, which may be based on the types of analysis and/or reports to be generated and/or on the amount of data to be processed and analyzed.

By providing anonymized data to the probabilistic engine 102, a number of analyses and reports may be generated without revealing any PII or other sensitive information. For example, the probabilistic engine 102 may operate to link or match a merchant's sales ledger data to de-identified payment network transaction data and to de-identified social media activity data. The linkages may be based on date data, time data, and location data, and also may be based on a predefined acceptable tolerance between the merchant data and the payment network transaction data and/or the social media activity data. The linkages, on their own, do not necessarily provide any intrinsic value, but later pattern analysis can provide valuable information for the merchant or merchants. Thus, in some embodiments, the report that is generated based on the linked data entries describes a pattern of activity over time for the individuals of the disparate data sets without divulging any PII. As a result, merchants may enjoy the use of a number of analytic and modeling applications including the ability to generate aggregate reports, probability scores, forecasting reports, benchmarking, affinity analysis, correlations, and model algorithms.

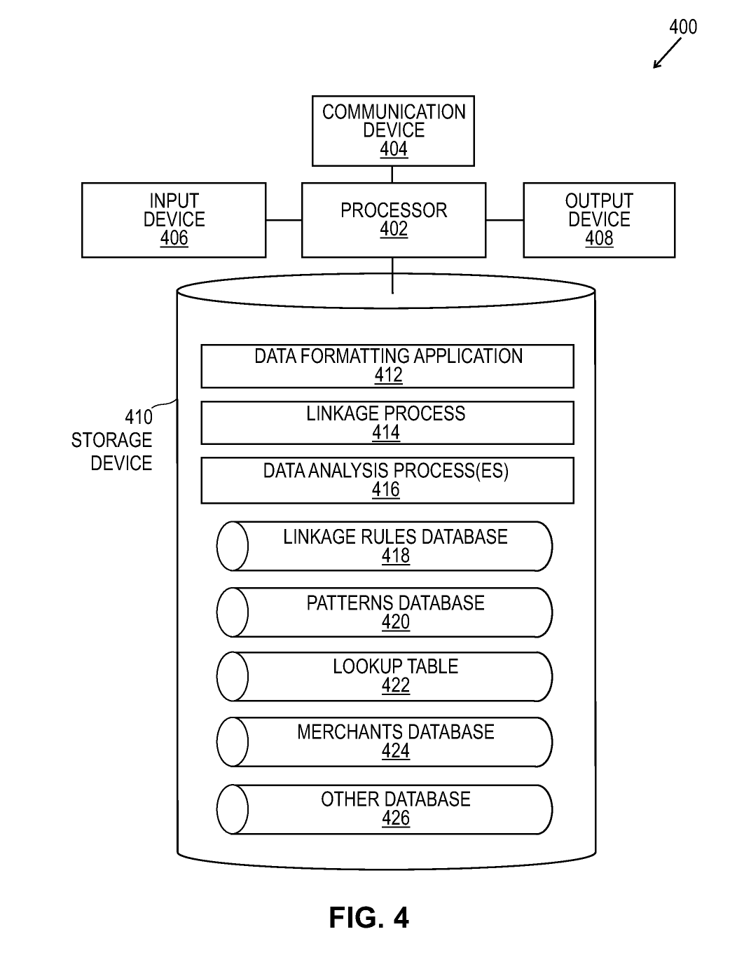

It should be noted that the embodiments described herein may be implemented using any number of different hardware configurations. For example, FIG. 4 illustrates an embodiment of an anonymized data analysis computer 400 that may, for example, be equivalent to the anonymized data analysis subsystem 101 of FIG. 1. The anonymized data analysis computer 400 comprises a processor 402, such as one or more commercially available Central Processing Units (CPUs) in the form of one-chip microprocessors, coupled to a communication device 404, which may be configured for communications with, for example, one or more of the anonymized data extract modules 118 to 130 shown in FIG. 1, and the like. The anonymized data analysis computer 400 further includes an input device 406 (for example, a computer mouse and/or keyboard that may be utilized to enter information such as business rules and/or logic) and an output device 408 (such as a computer monitor (which may be a touch screen) or printer to, for example, output reports and/or support user interfaces).

The processor 402 is also configured to communicate with a storage device 410. The storage device 410 may comprise any appropriate information storage device, including combinations of magnetic storage devices (e.g., a hard disk drive), optical storage devices, and/or semiconductor memory devices. The storage device 410 may therefore be any type of non-transitory computer readable medium and/or any form of computer readable media capable of storing computer instructions and/or application programs and/or data. It should be understood that non-transitory computer-readable media comprise all computer-readable media, with the sole exception being a transitory, propagating signal.

In some embodiments, the storage device 410 stores computer programs and/or applications and/or computer readable instructions operable to control the processor 402 to operate in accordance with any of the embodiments described herein. For example, a data formatting application 412 may include instructions configured to cause the processor to receive de-identified data of individuals from a plurality of data sources and to format that data into a predetermined dataset format. For example, a first set of de-identified data and a second set of de-identified data may be formatted into a first formatted dataset grouped by UID, and a second formatted dataset grouped by UID. In some implementations, both the first formatted dataset and the second formatted dataset include date data, time data, location data and activity data. The storage device 410 may also store a linkage process 414 including instructions configured to cause the processor 402 to link at least a portion of the data entries of the first data set to data entries of the second data set based on the date data, the time data, and the location data. A data analysis process 416 may also be stored by the storage device 410, and may include instructions configured to cause the processor 402 to analyze the linked data and/or to generate one or more reports or analyses based on the linked data. The reports and/or analysis may describe a pattern of activity over time for the individuals of the first and second datasets. The computer programs or applications 412, 414 and 416 may be stored in a compressed, uncompiled and/or encrypted format. The programs 412, 414 and 416 may furthermore include other program elements, such as an operating system, a database management system, and/or device drivers used by the processor 402 to interface with peripheral devices, such as the input devices 406 and/or output devices 408.

As used herein, information may be “received” by or “transmitted” to, for example, the anonymized data analysis computer 400 from/to another device. Also, information may be received or transmitted between a computer software application or module within the anonymized data analysis computer 400 and another software application, module, or any other source.

Referring again to FIG. 4, in some embodiments the storage device 410 further stores a linkage rules database 418, a patterns database 420, a lookup table 422, a merchants database 424, and other databases 426. The linkage rules database 418 may contain rules and/or criteria that can be utilized to match groups of data across various datasets, as described herein. The patterns database 420 may include data, rules and/or criteria which define one or more pre-defined and/or predetermined data patterns that have been identified for analysis, which may be utilized, for example, by the data formatting application 412 when arranging data from the anonymized data extract modules and/or when filtering or cleansing received data to remove unnecessary data. The lookup table 422 stores one or more de-identified UIDs with their associated assigned profile identifiers when such de-identified UIDs are removed from datasets during processing. During later data analysis and/or report generation processing, the lookup table 422 can then be searched, for example, to obtain at least one de-identified UID associated with analyzed data to enable detailed de-identified data to be added to the analysis and/or to the report. The merchant database 424 may store a “business classification,” which is a group of merchants and/or businesses, by the type of goods and/or service the merchant and/or business provides. For example, a particular group of merchants can include merchants that provide similar goods and/or services. In addition, the merchants and/or businesses can be classified based on geographical location, sales, and any other type of classification, which can be used, for example, to associate a merchant and/or business with similar goods, services, locations, economic and/or business sector, industry and/or industry group when the data is analyzed.

It should be noted that the databases described herein are only examples, and are not intended to be limiting in any manner. Therefore, additional and/or different information may actually be stored therein than that described. Moreover, various databases might be split or combined in accordance with any of the embodiments described herein. For example, the merchant database 424 and patterns database 420 might be combined and/or linked to each other.

Pursuant to some embodiments, the operation of the transaction analysis system 100 and/or the anonymized data analysis subsystem 101 may be based on several assumptions or rules to protect PII. Such assumptions or rules may include ensuring that any particular combined or matched data set (for example, a combined data set that includes data from a payment network, from one or more merchants, and from one or more social media operators) is not disclosed to the merchant (who is the client requesting analysis information), that all applications are specific to the merchant and are not to be shared with other parties, and that any reports that are created use a plurality of matched data and no single transaction matches.

Pursuant to some embodiments, the techniques described above may be used in conjunction with a number of different applications. For example, in some embodiments, enhanced and/or aggregated reports may be produced, for example with inferred match links to merchant unique identifiers utilizing additional “SKU” data from the merchant (e.g., where the SKU level data is received in the merchant transaction data at 108). In some embodiments, data append services may be delivered at the de-identified merchant unique identifier level.

Thus, embodiments of the present invention allow merchants, networks, and others entities to accurately generate and investigate transaction profiles and/or activity profiles, without need for added controls to protect and secure PII.

Pursuant to some embodiments, systems, methods, means, computer program code and computerized processes are provided to generate matches or linkage between de-identified data in different transaction data sets and/or activity data sets. In some embodiments, the systems, methods, means, computer program code and computerized processes include receiving a first set of de-identified data of individuals from a first data source and a second set of de-identified data of individuals from a second data source, formatting the first set of de-identified data and the second set of de-identified data to provide a first formatted data set and a second formatted data set. Each entry of the first and second formatted data sets includes date data, time data, location data and activity data. Such embodiments also include linking the data entries of the first data set to data entries of the second data set based on the date data, the time data, and the location data, and generating a report based on the linked data entries that describes a pattern of activity over time for the individuals of the first and second data sets.

Although embodiments disclosed herein have been described in connection with specific exemplary implementations, it should be understood that various changes, substitutions, and alterations apparent to those skilled in the art can be made without departing from the spirit and scope of the invention as set forth in the appended claims. Although a number of “assumptions” are provided herein, the assumptions are provided as illustrative but not limiting examples of one or more particular embodiments, and those skilled in the art appreciate that other embodiments may have different rules or assumptions.

What is claimed is:

1. A method, comprising:
receiving, by a processor, a plurality of disparate anonymized datasets originating from a plurality of different data sources, each anonymized dataset comprising de-identified data of individuals;
formatting, by the processor, the de-identified data of each of the plurality of the disparate anonymized datasets to provide a plurality of formatted anonymized datasets, each formatted anonymized dataset containing data entries for the de-identified individuals comprising a user unique identifier (UID), date data, time data, location data, and activity data;
linking, by the processor, the data entries of the de-identified individuals of the plurality of formatted datasets by matching at least the date data, time data, and location data;
analyzing the activity data of the linked data entries; and
generating, by the processor, at least one report based on the analysis.

2. The method of claim 1, further comprising transmitting the at least one report to at least one client.

3. The method of claim 1, wherein formatting further comprises arranging, by the processor, the de-identified data of the individuals in accordance with at least one pre-determined pattern.

4. The method of claim 3, further comprising filtering the arranged de-identified data in accordance with at least one predetermined time-based criteria.

5. The method of claim 4, wherein the time-based criteria comprises at least one of a time frame, a time range, and a tolerance rule.

6. The method of claim 3, further comprising filtering the arranged de-identified data in accordance with at least one predetermined client-based criteria.

7. The method of claim 6, wherein the client-based criteria comprises at least one of a merchant identifier, a merchant type, and a merchant group.

8. The method of claim 3, further comprising:
assigning a profile identifier to each pattern of the at least one predetermined pattern; and
removing, by the processor, the UID prior to linking the data entries of the de-identified individuals of the plurality of formatted datasets.

9. The method of claim 8, further comprising storing each profile identifier in a lookup table.

10. The method of claim 9, further comprising, prior to generating at least one report:
searching, by the processor, the lookup table;
obtaining at least one user unique identifier (UID) associated with the analyzed data;
locating, by the processor, detailed de-identified data associated with the UID; and
adding, by the processor, the detailed de-identified data to the analysis.

11. The method of claim 1, wherein the at least one report describes at least one pattern of activity associated with the de-identified individuals of the plurality of anonymized datasets.

12. The method of claim 1, wherein the plurality of different data sources comprises at least two of a payment network, a merchant, a mobile network operator (MNO), a public transportation authority, and a social media organization.

13. An apparatus, comprising:
a processor;
a communication device operably connected to the processor; and
a storage device operably connected to the processor and storing instructions configured to cause the processor to:
receive a plurality of disparate anonymized datasets originating from a plurality of different data sources, each anonymized dataset comprising de-identified data of individuals;
format the de-identified data of each of the plurality of the disparate anonymized datasets to provide a plurality of formatted anonymized datasets, each formatted anonymized dataset containing data entries for the de-identified individuals comprising a user unique identifier (UID), date data, time data, location data, and activity data;
link the data entries of the de-identified individuals of the plurality of formatted datasets by matching at least the date data, time data, and location data;
analyze the activity data of the linked data entries; and
generate at least one report based on the analysis.

14. The apparatus of claim 13, wherein the storage device stores further instructions configured to cause the processor to transmit the at least one report to at least one client.

15. The apparatus of claim 13, wherein the storage device stores further instructions configured to cause the processor to, during formatting, arrange the de-identified data of the individuals in accordance with at least one pre-determined pattern in accordance with at least one of at least one predetermined time-based criteria and at least one predetermined client-based criteria.

16. The apparatus of claim 13, wherein the storage device further comprises a lookup table, and wherein the storage device stores further instructions configured to cause the processor to:
assign a profile identifier to each pattern of the at least one predetermined pattern;
remove the user unique identifier (UID) prior to linking the data entries of the de-identified individuals of the plurality of formatted datasets; and
store each profile identifier in a lookup table.

17. The apparatus of claim 16, wherein the storage device stores further instructions configured to cause the processor to, prior to generating at least one report:
search the lookup table;
obtain at least one user unique identifier (UID) associated with the analyzed data;
locate detailed de-identified data associated with the UID; and
add the detailed de-identified data to the analysis.

18. The apparatus of claim 13, wherein the plurality of different data sources comprises at least two of a payment network computer, a merchant computer, a mobile network operator (MNO) computer, a public transportation authority computer, and a social media organization computer.

19. A system, comprising:
a probabilistic engine;
an anonymized data formatting engine operably connected to the probabilistic engine; and
a reporting engine operably connected to the probabilistic engine;
wherein the probabilistic engine comprises a processor and a storage device operably connected to the processor and configured to cause the processor to:
receive, from the anonymized data formatting engine, a plurality of disparate anonymized datasets originating from a plurality of different data sources, each anonymized dataset comprising de-identified data of individuals;
format the de-identified data of each of the plurality of the disparate anonymized datasets to provide a plurality of formatted anonymized datasets, each formatted anonymized dataset containing data entries for the de-identified individuals comprising a user unique identifier (UID), date data, time data, location data, and activity data;
link the data entries of the de-identified individuals of the plurality of formatted datasets by matching at least the date data, time data, and location data;
analyze the activity data of the linked data entries; and
transmit the analysis to the reporting engine to generate at least one report.

20. The system of claim 19, further comprising a matching rules engine operably connected to the probabilistic engine, the matching rules engine configured to provide the probabilistic engine with criteria for linking the data entries of the de-identified individuals.

21. The system of claim 19, further comprising a lookup table operably connected to the anonymized data formatting engine and to the reporting engine, wherein the anonymized data formatting engine operates to:
arrange the de-identified data of the individuals in accordance with at least one pre-determined pattern;
assign a profile identifier to each pattern of the at least one predetermined pattern;
remove the UID prior to linking the data entries of the de-identified individuals of the plurality of formatted datasets; and
store each profile identifier in the lookup table.
